(19) United States
(12) Patent Application Publication
(10) Pub. No.: US 2009/0144667 A1
(43) Pub. Date: Jun. 4, 2009

(54) Apparatus, method, computer program and user interface for enabling user input

(75) Inventors: Joakim Christoffersson, Malmo (SE); Christian R. Kraft, Frederiksberg (DK)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 11/998,643

(22) Filed: Nov. 30, 2007

(51) Int. Cl. G06F 3/033

(52) U.S. Cl. 715/863

(57) ABSTRACT

An apparatus including a display for presenting text; a touch sensitive input device configured to enable a user to make a trace input via the display; and a processor, wherein the processor is configured to detect a first trace input that starts at a predetermined first location and extends across the touch sensitive input device to a second location wherein the processor is configured such that the detection of the first trace input actuates the deletion of the text presented between the predetermined first location and the second location.

### FIELD OF THE INVENTION

Embodiments of the present invention relate to an apparatus, method, computer program and user interface for enabling user input. In particular, they relate to an apparatus, method, computer program and user interface for enabling user input using a touch sensitive input device such as a touch sensitive display.

### BACKGROUND TO THE INVENTION

Apparatus having touch sensitive input devices, such as touch sensitive displays, which enable a user to input text are well known. It is also well known for such input devices to provide a means for enabling a user to delete text if, for example, they make an error when entering the text or they wish to edit the text.

One method of deleting text displayed on a touch sensitive display is to provide a dedicated area of the touch sensitive display to act as a delete key so that when the user actuates that dedicated area of the display the character immediately preceding the text entry point is deleted.

### BRIEF DESCRIPTION OF THE INVENTION

According to one embodiment of the invention there is provided an apparatus comprising: a display for presenting text; a touch sensitive input device configured to enable a user to make a trace input via the display; and a processor, wherein the processor is configured to detect a first trace input that starts at a predetermined first location and extends across the touch sensitive input device to a second location wherein the processor is configured such that the detection of the first trace input actuates the deletion of the text presented between the predetermined first location and the second location.

The first location is predetermined in that it is determined before the detection of a trace input.

In a first embodiment the predetermined first location exists before the trace input is initiated. A visual indicator may be used to mark the predetermined first location.

In a different embodiment the predetermined first location may be determined as a location at which the trace input started.

The predetermined first location may be associated with a certain point of the text. For example the predetermined first location may be associated with the text entry point so that whenever the text entry point is moved, either manually or automatically, the predetermined first location is also moved and similarly if the predetermined first location is moved the text entry point is also moved. The predetermined first location may be associated with the text entry point so that it is always positioned adjacent to the text entry point.

Embodiments of the invention provide the advantage that a user can delete text simply by making a trace input extending over the area of the display in which the text they wish to delete is presented. This enables a user to delete multiple characters in a single actuation which provides a quick and efficient way of deleting text.

As the trace input extends over the text which is to be deleted a user can clearly see the text that will be deleted as they are making the trace. This makes the input intuitive and also reduces the likelihood of the user deleting the wrong text.

Also there is no requirement to have a portion of the touch sensitive display to be dedicated to the function of deleting text which therefore increases the area of the display available for presenting text.

In some embodiments of the invention the predetermined first location is moveable with respect to the text presented on the display. This provides the advantage that it enables a user to move the predetermined first location to various points within the text and so enables a user to delete text from any point within the text.

This also provides the advantage that as the text presented on the display changes, for example as text is entered, deleted or scrolled through, the actual position of the predetermined first location on the touch sensitive input device may change.

In some embodiments of the invention the predetermined first location moves to the second location when the first trace input is completed and the processor is configured to detect a second trace input starting at the new position of the predetermined first location and extending in the opposite sense to the first trace input to a third location and the processor is configured such that the detection of the second trace input actuates the reinstatement of text which was presented between the predetermined first location and the third location and was deleted by the first trace input.

This provides the advantage that if a user inadvertently deletes the wrong text with the first trace input this error can be easily corrected by making a second trace in the opposite sense.

According to another embodiment of the invention there is provided a method comprising: presenting text on a display; detecting a first trace input on a touch sensitive user input device, the first trace input starting at a predetermined first location and extending across the touch sensitive input device to a second location; wherein the detection of the first trace input actuates the deletion of the text presented between the predetermined first location and the second location.

According to another embodiment of the invention there is provided a computer program comprising program instructions for controlling an apparatus, the apparatus comprising, a display for presenting text and a touch sensitive input device configured to enable a user to make an input via the display, the program instructions providing, when loaded into a processor: means for detecting a first trace input on the touch sensitive user input device, the first trace input starting at a predetermined first location and extending across the touch sensitive input device to a second location; means for enabling the detection of the first trace input to actuate the deletion of the text presented between the predetermined first location and the second location.

According to another embodiment of the invention there is provided a user interface comprising: a display for presenting text; a touch sensitive input device configured to enable a user to make a trace input via the display; wherein the user interface is configured such that the detection of a trace input that starts at a predetermined first location and extends across the touch sensitive input device to a second location actuates the deletion of the text presented between the predetermined first location and the second location.

According to another embodiment of the invention there is provided an apparatus comprising: a display for presenting text; a touch sensitive input device configured to enable a user to make a trace input; and a processor, wherein the processor is configured to detect a trace input across the touch sensitive input device from a first location to a second location wherein the processor is configured such that the detection of the first trace input actuates the deletion of the text presented in the portion of the display corresponding to the portion of the touch sensitive input device between the predetermined first location and the second location.

The apparatus may be for wireless communication.

### BRIEF DESCRIPTION OF THE DRAWINGS

For a better understanding of the present invention reference will now be made by way of example only to the accompanying drawings in which:

FIG. 1 schematically illustrates an electronic apparatus;

FIG. 2 illustrates a flow chart showing method blocks of a first embodiment of the present invention;

FIG. 3 illustrates a graphical user interface according to an embodiment the present invention;

FIGS. 4A to 4C illustrate the first embodiment of the present invention in use;

FIG. 5 illustrates a flow chart showing method blocks of a second embodiment of the present invention;

FIGS. 6A to 6C illustrate the second embodiment of the present invention in use; and

FIGS. 7A to 7D illustrate another embodiment of the present invention in use.

### DETAILED DESCRIPTION OF EMBODIMENTS OF THE INVENTION

The Figures illustrate an apparatus 1 comprising: a display 11 for presenting text 49; a touch sensitive input device 13 configured to enable a user to make a trace input via the display 11; and a processor 3, wherein the processor 3 is configured to detect 25 a first trace input that starts at a predetermined first location and extends across the touch sensitive input device 13 to a second location 65, 91 wherein the processor 3 is configured such that the detection 25 of the first trace input actuates the deletion 27 of the text presented between the predetermined first location and the second location 65, 91.

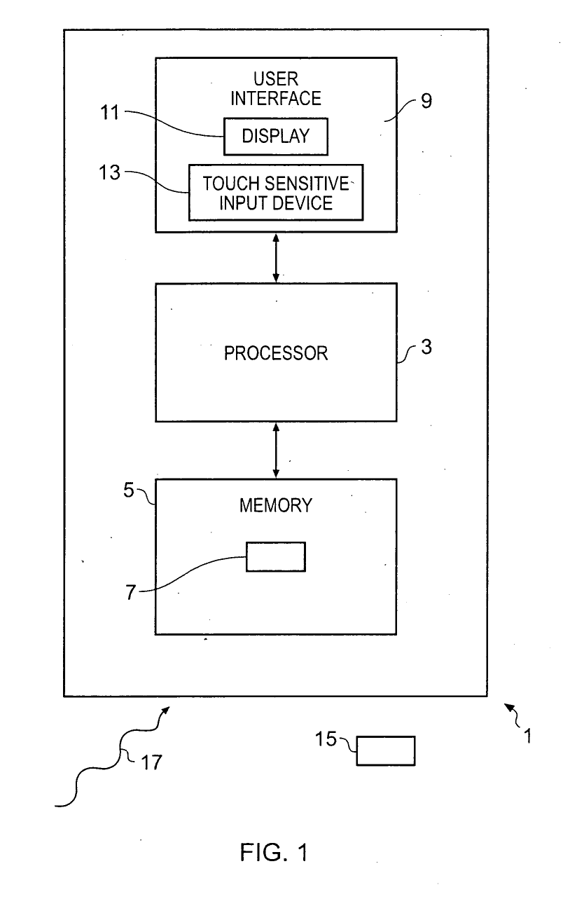

FIG. 1 schematically illustrates an electronic apparatus 1 according to an embodiment of the invention. Only the features referred to in the following description are illustrated. It should, however, be understood that the apparatus 1 may comprise additional features that are not illustrated. The electronic apparatus 1 may be, for example, a mobile cellular telephone, a personal computer, a personal digital assistant or any other electronic device that uses a touch sensitive input device to enable a user to input text into the apparatus 1. The electronic apparatus 1 may be a handheld apparatus 1 which can be carried in a user's hand, handbag or jacket pocket for example.

The illustrated electronic apparatus 1 comprises: a user interface 9, a memory 5, and a processor 3. The processor 3 is configured to receive input commands from and provide output commands to the user interface 9. The processor 3 is also configured to write to and read from the memory 5.

The user interface 9 comprises a display 11 and a touch sensitive input device 13. The display 11 presents a graphical user interface 41 to a user of the apparatus 1. An example of a graphical user interface 41 according to an embodiment of the invention is illustrated in FIG. 3. The display 11 also presents text 49 to a user of the apparatus 1.

The touch sensitive input device 13 is arranged relative to the display 11 so that a user can make inputs via the display 11. The touch sensitive input device 13 may be integrated into the display 11 to form a touch sensitive display. The touch sensitive input device 13 may be actuated by a user contacting the surface of the touch sensitive input device 13 with a user input device such as their finger or a stylus. A user may contact the surface of the touch sensitive input device 13 by physically touching the surface of the touch sensitive input device 13 with the user input device or by bringing the user input device close enough to the surface to activate the sensors of the touch sensitive input device 13.

The user interface 9 may also comprise other user input means such as, any one or more of a key, a keypad, a joystick or roller or any other suitable user input device.

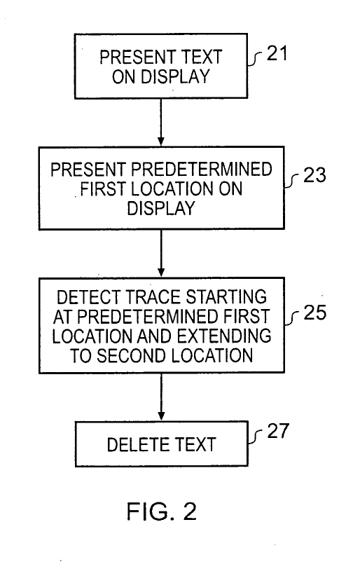

The memory 5 stores computer program instructions 7, which when loaded into the processor 3, enable the processor 3 to control the operation of the apparatus 1 as described below. The computer program instructions 7 provide the logic and routines that enables the electronic apparatus 1 to perform the method illustrated in FIG. 2.

The memory 5 also stores text which is displayed on the display 11. The text may have been input using the touch sensitive input device 13 or may have been received by the apparatus 1.

The computer program instructions 7 may arrive at the electronic device 1 via an electromagnetic carrier signal 17 or be copied from a physical entity such as a computer program product 15, a memory device or a record medium such as a CD-ROM or DVD, where it has been tangibly encoded.

A method of controlling the apparatus 1, according to the present invention, is illustrated schematically in FIG. 2.

At block 21 text 49 is presented to the user of the apparatus 1 on the display 11. The text 49 comprises a series of characters such as letters or numbers. At block 23 the predetermined first location is also presented on the display 11. An icon 53 may be presented on the display 11 to indicate the position of the predetermined first location.

The first location is predetermined in relation to subsequent trace inputs. The first location may also be predetermined in that it exists before the trace is initiated so that the processor 3 will recognize any trace input which starts at the predetermined first location as an instruction to delete or undelete text.

The predetermined first location is not fixed with respect to the display 11 and the touch sensitive input device 13. The physical position of the predetermined first location on the touch sensitive input device 13 may change as the text presented on the display 11 changes as text is entered, deleted or scrolled through.

The predetermined first location may be associated with the text entry point so that the predetermined first location moves whenever the text entry point is moved. For example whenever text is entered or deleted the cursor, which indicates the text entry point, will move automatically along the display as the individual characters are entered or deleted and the predetermined first location will move with it. Also the user may be able to manually move the text entry point to different points within the text, for example if they wish to insert characters in the middle of the text rather than at the end of the text, in which case the predetermined first location would also move.

The predetermined first location may be positioned adjacent to the text entry point. The predetermined first location may immediately follow the text entry point.

Although blocks 21 and 23 are illustrated sequentially in FIG. 2 they may occur simultaneously so that both the text 49 and the predetermined first location are presented at the same time.

At block 25 the processor 3 detects a trace starting at the predetermined first location and extending to a second location 65. The detection 25 of the trace will actuate, at block 27, the deletion of text presented on the display between the predetermined first location and the second location 65.

In some embodiments the deletion 27 of the text 49 may only be actuated once the processor 3 has detected that the trace input has been completed. The processor 3 may detect that the trace input has been completed if no further input is received within a predetermined time or if the contact between the user input device and the touch sensitive input device 13 is broken. Once the processor 3 has detected that the trace has been completed the processor 3 will then determine that the trace has extended to the second location 65 and then delete 27 all of the text 49 positioned between the first location and the second location 65 at the same time.

In an alternative embodiment of the invention the deletion 27 of the text 49 may be actuated whenever the processor 3 detects that the trace has extended over a portion of the display 11 in which a character of text 49 is presented. The steps of detecting that the trace has extended to a second location and then deleting 27 the text 49 may be repeated multiple times so that each individual characters are deleted sequentially. The individual characters may be deleted as the trace input is being made so that some of the text 49 is deleted before the trace input has been completed.

The method illustrated in FIG. 2 therefore provides a method of enabling a user to delete any amount of text 49 with a single actuation on a touch sensitive user input device 13.

FIG. 3 illustrates a graphical user interface 41 according to an embodiment of the invention. In this particular embodiment the apparatus 1 is a mobile cellular telephone and the graphical user interface 41 illustrated is one which enables a user to access the cellular telephone functions such as entering telephone numbers and making calls.

The graphical user interface 41 is presented on a touch sensitive display 11. An ITU-T keypad 47 is presented in a first portion 43 of the display 11. The ITU-T keypad enables a user of the apparatus 1 to input numbers into the apparatus 1 by contacting the appropriate areas of the touch sensitive display 11.

Icons 48 are also presented in the first portion 43. The icons 48 are associated with the functions options, call and back. Actuating these icons 48 will enable a user to enter an options menu, make a call to the entered number or exit the telephone functions respectively.

Text 49 is presented in a second portion 45 of the display 11. In the graphical user interface 41 illustrated in FIG. 3 the text 49 is the number +452032 which is part of a telephone number.

A cursor 51 is also displayed in the second portion 45. The cursor 51 indicates the location of the text entry point to a user. The text entry point is the position within the text 49 at which the next character input by the user will be inserted. In the graphical user interface 41 in FIG. 3 the cursor 51 is presented at the end of the text 49 immediately following the last character of the text 49.

An icon 53 is also displayed in the second portion. The icon 53 is presented adjacent to the cursor 51 and provides an indication of the position of the predetermined first location. The icon 53 indicates to the user that any trace starting from the icon 53 will cause any text covered by the trace to be deleted.

The icon 53 includes an arrow to indicate to a user which direction a trace should be made to delete text.

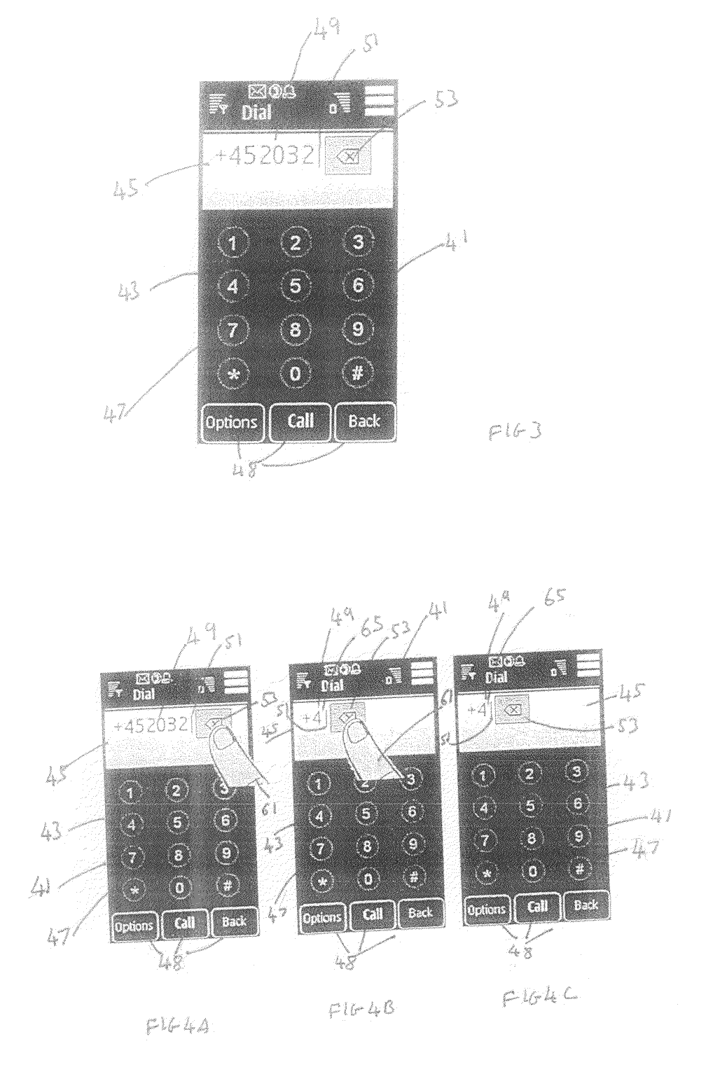

FIGS. 4A to 4C illustrate the graphical user interface 41 of FIG. 3 being used to delete text.

In FIG. 4A the graphical user interface 41 illustrated in FIG. 3 is presented to a user with the cursor 51 and the icon 53 indicative of the predetermined first location presented at the end of the number +452032. The user has started making a trace input by touching the touch sensitive display 11 with their finger 61 in the area where the icon 53 is presented.

The user then makes a trace input by moving their finger 61 to the left along the surface of the display 11 until their finger 61 is in a second location 65 to the right of and adjacent to the number 4 as illustrated in FIG. 4B. When the processor 3 has detected that the trace has extended to the second location 65 the processor 3 will delete all of the text which was displayed between the first location and the second location 65 so that in the graphical user interface 41 illustrated in FIG. 4B the numbers 52032 have been deleted and are no longer presented on the display 11.

Once the text has been deleted both the cursor 51 and the icon 53 are moved to the second location so that, as illustrated in FIG. 4B, the cursor 51 and icon 53 are positioned to the right of and adjacent to the number 4 on the display 11. When the user removes their finger 61 from the display 11 the cursor 51 and the icon 53 will remain at the point where the trace ended so that the predetermined first location is now positioned at the second position 65 as illustrated in FIG. 4C.

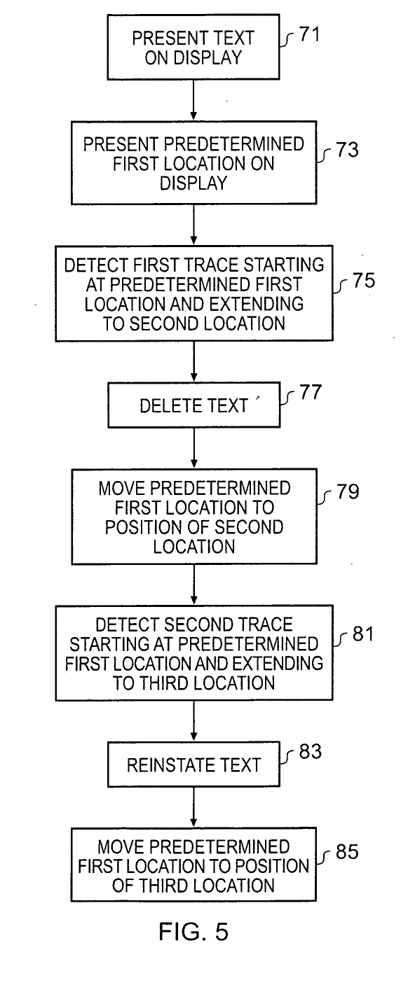

A method of controlling the apparatus 1, according to another embodiment of the present invention, is illustrated schematically in FIG. 5.

Blocks 71 to 77 of FIG. 5 are the same as blocks 21 to 27 of FIG. 2 and provide a method of deleting text in response to a first trace input.

At block 79, after the text 49 has been deleted, the predetermined first location is moved to the position at which the first trace ended so that the predetermined first location is now positioned at the second location. The predetermined location may be moved once the trace input has been completed or every time an individual character is deleted.

At block 81 the processor 3 detects a second trace which starts at the new position of the predetermined first location and extends in the opposite direction to the first trace to a third location. The detection 81 of the second trace will actuate, at block 83, the reinstatement of text which was presented on the display 11 between the new position of the predetermined first location and the third location and which was deleted in response to the first trace.

When the text is reinstated it is presented on the display 11 again. In order to enable text to be reinstated, when text is deleted it may still be temporarily stored in the memory 5 even though it is no longer presented on the display 11.

At block 85, after the text has been reinstated, the predetermined first location is moved to the position at which the second trace ended so that the predetermined first location is now positioned at the third location.

In some embodiments of the invention it may only be possible to reinstate the text by the second trace input if no other inputs are made between the first trace input and the second trace input. In some embodiments it may also only be possible to reinstate text if the second trace input is made within a predetermined time of the first trace input.

The first trace input may be completed and the second trace input may be started by reversing the direction or sense in which the trace is being made. That is the user input device may remain in contact with the surface of the touch sensitive user input device 11 until after the second trace input is completed. This enables a user to delete and reinstate text simply by moving a user input device back and forth on the surface of the touch sensitive input device 11.

The method illustrated in FIG. 5 therefore provides a method of enabling a user to reinstate text which has been deleted. This provides the advantage that if a user accidentally deletes the wrong text, this error can be quickly and easily corrected with a single user input.

FIGS. 6A to 6C illustrate the graphical user interface 41 of FIG. 3 being used to delete text and then reinstate the deleted text.

In FIG. 6A the graphical user interface illustrated in FIG. 3 is presented to a user. The cursor 51 and the icon 53 indicative of the predetermined first location are presented at the end of the number +452032 in the second portion 45 of the display 11.

In the example in FIGS. 6A to 6C the user wishes to delete the numbers 52032 from the text 49. The user has started making a trace by touching the display 11 with their finger 61 in the area where the icon 53 is presented.

The user then makes a first trace input by moving their finger 61 to the left along the surface of the display 11 until their finger 61 is in a second location 91. In the example in FIG. 6B the user has moved their finger 61 too far so that the second location 91 is to the right of the + character as illustrated in FIG. 6B. When the processor 3 has detected that the trace has extended to the second location 91 the processor 3 will delete all of the text which was displayed between the first location and the second location 91 so that in the graphical user interface 41 illustrated in FIG. 6B the numbers 452032 have been deleted so that they are no longer presented on the display 11.

In FIG. 6B, once the text has been deleted both the cursor 51 and the icon 53 are moved to the second location 91 so that the cursor 51 and icon 53 are to the right of the + character.

The user reinstates the number 4, which was deleted erroneously, by making a second trace starting from the new position of the predetermined first location and extending in the opposite direction to the first trace to a third location 93. As illustrated in FIG. 6C the user has touched the display 11 in the area of the display 11 where the icon 53 is presented and then moved their finger 61 to the right to a third location 93. The processor 3 has detected that the number 4 was presented on the display 11 between the first location and the third location but was deleted in response to the first trace and has reinstated the number 4 so that it is presented on the display 11 again.

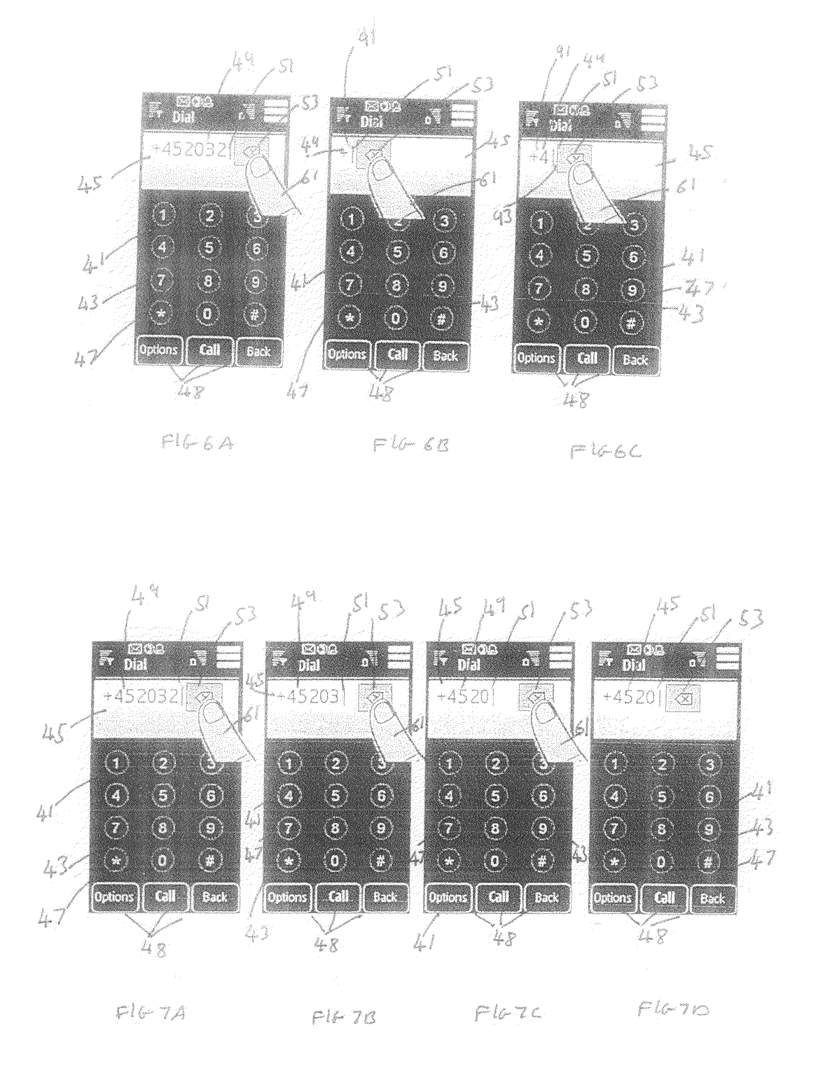

FIGS. 7A to 7D illustrate the graphical user interface 41 of FIG. 3 being used to delete individual characters of the text 49 according to a further embodiment of the invention. In this embodiment, as well as being able to delete text by making trace inputs from the predetermined first location, a user can also delete individual characters of the text 49 by making a tap input on the area of the display 11 in which the icon 53 indicative of the predetermined first location is presented.

In FIG. 7A the graphical user interface illustrated in FIG. 3 is presented to a user. The cursor 51 and the icon 53 indicative of the predetermined first location are presented at the end of the number +452032 in the second portion 45 of the display 11.

In the example in FIGS. 7A to 7D the user wishes to delete the numbers 3 and 2 from the text 49. In FIG. 7A the user makes a tap input by tapping the display 11 in the area where the icon 53 is presented.

In response to the tap input the individual character immediately preceding the text entry point will be deleted. In the example in FIG. 7A, the number 2 is deleted so that, as illustrated in FIG. 7B, the text 49 presented on the display is now the number +45203.

The user then makes a second tap input in the same manner so that the number 3 is deleted and the text 49 presented on the display is the number +4520, as illustrated in FIG. 7C.

In FIG. 7D the processor 3 has not detected any further inputs within a predetermined time and so has moved the icon 53 so that it is presented on the display adjacent to the cursor 51.

This provides the advantage that the touch sensitive display 11 can also be used to easily delete individual characters. Also as a number of different ways of deleting text may be provided this enables the user to use the method which is easiest for them.

Presenting the icon 53 which enables the individual characters adjacent to text entry point also provides the advantage that a user can easily see what text will be deleted and reduces the likelihood of the wrong characters being deleted.

The blocks illustrated in the FIGS. 2 and 5 may represent steps in a method and/or sections of code in the computer program 7. The illustration of a particular order to the blocks does not necessarily imply that there is a required or preferred order for the blocks and the order and arrangement of the blocks may be varied.

Although embodiments of the present invention have been described in the preceding paragraphs with reference to various examples, it should be appreciated that modifications to the examples given can be made without departing from the scope of the invention as claimed. For example in the above embodiments the invention has been used to delete numbers from a telephone number. It is to be appreciated that the invention could also be used to delete other text such as messages.

Features described in the preceding description may be used in combinations other than the combinations explicitly described.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
a display for presenting text;
a touch sensitive input device configured to enable a user to make a trace input via the display; and
a processor, wherein the processor is configured to detect a first trace input that starts at a predetermined first location and extends across the touch sensitive input device to a second location wherein the processor is configured such that the detection of the first trace input actuates the deletion of the text presented between the predetermined first location and the second location.

2. An apparatus as claimed in claim 1 wherein the predetermined first location is moveable with respect to the text presented on the display.

3. An apparatus as claimed in claim 2 wherein the predetermined first location moves to the second location when the first trace input is completed.

4. An apparatus as claimed in claim 3 wherein the processor is configured to detect a second trace input starting at the predetermined first location and extending in the opposite sense to the first trace input to a third location and the processor is configured such that the detection of the second trace input actuates the reinstatement of text which was presented between the predetermined first location and the third location and was deleted by the first trace input.

5. An apparatus as claimed in claim 4 wherein the predetermined first location moves to the third location when the second trace input is completed.

6. An apparatus as claimed in claim 1 wherein the predetermined first location follows the text entry point.

7. An apparatus as claimed in claim 1 wherein an icon is presented indicating the predetermined first location.

8. An apparatus as claimed in claim 7 wherein the icon moves as the user makes a trace input which starts at the predetermined first location.

9. An apparatus as claimed in claim 1 wherein the processor is configured such that the deletion of the text is actuated once the completion of the first trace is detected.

10. An apparatus as claimed in claim 1 wherein the processor is configured such that the deletion of each character of the text is actuated whenever the processor detects that the first trace has extended over the portion of the display in which the character is presented.

11. An apparatus as claimed in claim 1 wherein the trace input is made by contacting the surface of the touch sensitive input device with a user input device and maintaining the contact between the touch sensitive input device and the user input device whilst moving the user input device across the surface of the touch sensitive device.

12. An apparatus as claimed in claim 1 wherein the processor is configured to detect a tap input at the predetermined first location and delete, in response to the detection of the tap input, the character immediately preceding the text entry point.

13. A method comprising:
presenting text on a display;
detecting a first trace input on a touch sensitive user input device, the first trace input starting at a predetermined first location and extending across the touch sensitive input device to a second location;
wherein the detection of the first trace input actuates the deletion of the text presented between the predetermined first location and the second location.

14. A method as claimed in claim 13 wherein the predetermined first location is moveable with respect to the text presented on the display.

15. A method as claimed in claim 14 comprising moving the predetermined first location to the second location when the first trace input is completed.

16. A method as claimed in claim 15 comprising detecting a second trace input on the touch sensitive device, the second trace input starting at the predetermined first location and extending in the opposite sense to the first trace input to a third location wherein the detection of the second trace input actuates the reinstatement of text which was presented between the predetermined first location and the third location and was deleted by the first trace input.

17. A method as claimed in claim 16 comprising moving the predetermined first location to the third location when the second trace input is completed.

18. A method as claimed in claim 13 wherein the predetermined first location follows the text entry point.

19. A method as claimed in claim 13 comprising presenting an icon indicating the predetermined first location.

20. A method as claimed in claim 13 comprising detecting a tap input at the predetermined first location and deleting, in response to the detection of the tap input, the character immediately preceding the text entry point.

21. A computer program comprising program instructions for controlling an apparatus, the apparatus comprising, a display for presenting text and a touch sensitive input device configured to enable a user to make an input via the display, the program instructions providing, when loaded into a processor:
means for detecting a first trace input on the touch sensitive user input device, the first trace input starting at a predetermined first location and extending across the touch sensitive input device to a second location;
means for enabling the detection of the first trace input to actuate the deletion of the text presented between the predetermined first location and the second location.

22. A physical entity embodying the computer program as claimed in claim 21.

23. An electromagnetic carrier signal carrying the computer program as claimed in claim 21.

24. A computer program comprising program instructions for causing a computer to perform the method of claim 13.

25. A user interface comprising:
a display for presenting text;
a touch sensitive input device configured to enable a user to make a trace input via the display;
wherein the user interface is configured such that the detection of a trace input that starts at a predetermined first location and extends across the touch sensitive input device to a second location actuates the deletion of the text presented between the predetermined first location and the second location.

26. A user interface as claimed in claim 25 wherein the predetermined first location is moveable with respect to the text presented on the display.

27. An apparatus comprising:
a display for presenting text;
a touch sensitive input device configured to enable a user to make a trace input; and
a processor, wherein the processor is configured to detect a trace input across the touch sensitive input device from a first location to a second location wherein the processor is configured such that the detection of the first trace input actuates the deletion of the text presented in the portion of the display corresponding to the portion of the touch sensitive input device between the predetermined first location and the second location.
